(19) United States
(12) Patent Application Publication
(10) Pub. No.: US 2025/0233127 A1
(43) Pub. Date: Jul. 17, 2025

(54) METHOD FOR PREPARING A HIGH-PERFORMANCE SILICON-CARBON COMPOSITE GRAPHITE MATERIALS

(71) Applicant: Glory Material Co., Ltd., New Taipei City (TW)

(72) Inventors: SHIAN-TSUNG CHOU, New Taipei City (TW); YU-SHIANG WU, New Taipei City (TW)

(21) Appl. No.: 18/413,742

(22) Filed: Jan. 16, 2024

(51) Int. Cl. H01M 4/36; H01M 4/02; H01M 4/38; H01M 4/587; H01M 4/62

(52) U.S. Cl. CPC H01M 4/364; H01M 4/386; H01M 4/587; H01M 4/622; H01M 2004/021; H01M 2004/027

(57) ABSTRACT

A method for preparing a high-performance silicon-carbon composite graphite material includes grinding and sieving a graphite material, a silicon material and a binder; the grinded and sieved graphite material, silicon material and binder being put into a high-speed mixer and mixed evenly, and then put into a mold and pressed into ingots; and using a heating treatment and carbonizing the ingots in an inert gas, cooling the ingots to room temperature, then the ingots being pulverized, grinded, mixed, sieved, and magnetic separation to obtain the high-performance silicon-carbon composite graphite material. The method improves the problem of large volume changes in silicon material during the charging and discharging process which usually results in materials powdered and structure collapse. The silicon material, the graphite material and the binder are easy to obtain, have micron grade particle sizes, are suitable produced by factory scale, and are conducive to commercialization.

### BACKGROUND OF THE INVENTION

### Field of the Invention

The present invention belongs to the technical field of lithium battery anode material, particularly refers to a method for preparing a high-performance silicon-carbon composite graphite material.

### Background of the Invention

With the development of modern society, lithium batteries have brought many conveniences to people's lives, and people's demand for battery energy density is also getting higher and higher. Various applications ranging from 3C products, power tools, electric vehicles to energy storage systems are constantly putting forward new requirements for battery performance. Improving the specific capacity of battery material is an important part of solving foregoing problems.

Currently, commercial lithium-ion battery anode material are still dominated by traditional graphite anode material. The actual specific capacity is close to the theoretical value of 372 mAh/g, and it is very difficult to improve the foregoing specific capacity. Therefore, there is an urgent need to develop new systems of negative electrode material. Silicon has the highest specific capacity (4200 mAh/g) and a suitable voltage platform (˜0.4 V vs Li/Li+). It is a new anode material with good application prospects and has become a new research hotspot. However, due to the lithium ions moving in and out of the intercalation during the charging and discharging process, the silicon anode material expands too much, causing the material to be pulverized and the structure to collapse from the copper foil current collector, then collectively falling off, resulting in the cycle life dropping rapidly. The actual performance is that the specific capacity decreases sharply during the charge and discharge cycle. Moreover, the silicon material used in the existing silicon-carbon anode material require high purity and most of them need to be grinded to a particle size of less than 200 nm, with a preferred particle size of 50-100 nm, resulting in extremely low production yield, demanding grinding equipment requirements, and high cost. It is seriously effecting the obstacles in improving the energy density of lithium batteries. Therefore, there is a need to provide a method for preparing a high-performance silicon-carbon composite graphite material that can solve the foregoing problems.

### SUMMARY OF THE INVENTION

In view of the shortcomings of the existing technology, the present invention provides a method for preparing a high-performance silicon-carbon composite graphite material, which improves the problem of material peel off caused by the expansion of silicon material during the charging and discharging process, and simultaneously utilizes the advantages of the conductive properties of carbon material to solve the problem of low 1st coulombic efficiency of silicon material in charging and discharging. The silicon material, the graphite material and the binder used are easy to obtain. The particle size is micron grade and suitable produced by factory scale, which is conducive to commercialization.

A method for preparing a high-performance silicon-carbon composite graphite material, wherein specific steps are as follows:
Step 1) Grinding and sieving a graphite material, a silicon material, and a binder.
Step 2) The graphite material, the silicon material and the binder are sieved, then put into a high-speed mixer and mixed evenly, then put into a mold and pressed into ingots.
Step 3) Use a heating treatment to carbonize the ingots obtained in step 2) in an inert gas, then cool the ingots to room temperature, then the ingots are pulverized, grinded, mixed, sieved, and magnetic separation to obtain the high-performance silicon-carbon composite graphite material.

Preferably, wherein the graphite material in step 1) is at least one of artificial graphite and mesocarbon microbeads, a particle size after sieving is 2-55 um.

Preferably, wherein the silicon material in step 1) is at least one of silicon and silicon oxide (SiOx), a particle size after sieving is 5-30 um.

Preferably, wherein the binder in step 1) is at least one of petroleum pitch, coal pitch, and phenolic resin, a particle size after sieving is 2-10 um.

Preferably, wherein a weight ratio of the graphite material, the silicon material, and the binder in step 2) is 1-1.2:4.8-5.5:1.8-2.4.

Preferably, wherein a temperature rise rate of the heating treatment in step 3) is 1-10° C./min, the heat treatment temperature is 800-1100° C., and the heat treatment time is 1-15 hours.

Preferably, wherein the inert gas in step 3) is at least one of argon and nitrogen.

Preferably, wherein a particle size of the high-performance silicon-carbon composite graphite material in step 3) is 5-40 um.

### Technical Problems to be Solved by this Invention

(1) Improve the problem of material peel off caused by the expansion of silicon material during charging and discharging.

(2) Utilize the advantages of the conductive properties of carbon material to improve the problem of low 1st coulombic efficiency of silicon material in the first charge and discharge of lithium batteries.

(3) Improve the bonding force and peel strength between the silicon material and the copper foil to improve the problem of low cycle life.

Compared with the prior art, the present invention has the following advantages:

The present invention provides a method for preparing a high-performance silicon-carbon composite graphite material. Since the graphite and the binder completely cover the silicon material, the uneven surface of the silicon material is filled, so that it can be better combined with the PVDF glue and adhere to the copper foil current collector, improves the problem of large volume changes in the silicon material during the charging and discharging process, which usually results in material powdered and structure collapse. At the same time, through the graphite and the binder, pressure is used to seal the silicon material completely and tightly inside the graphite particles, so that the outer layer is evenly and tightly covered with a thick amorphous carbon, and the surface defects caused by grinding of the silicon material are filled up. Thereby achieving the effect of improving 1st coulombic efficiency. The silicon material, the graphite material and the binder used in the method of the present invention are easy to obtain, have micron grade particle sizes, are suitable produced by factory scale, and are conducive to commercialization.

### BRIEF DESCRIPTION OF THE DRAWINGS

FIG. 1 is a peeling strength schematic diagram of the embodiments and comparative examples of the present invention.

FIG. 2 is a diagram of each component of the silicon-carbon molding pressure mold for the silicon-carbon composite graphite material of the present invention.

FIG. 3 is a combined diagram of the silicon-carbon molding pressure mold for the silicon-carbon composite graphite material of the present invention.

FIG. 4 is a photo of the silicon-carbon composite graphite precursor negative electrode material of the present invention after being carbonized by heat treatment in powdered ingots.

FIG. 5 is a scanning electron microscope (SEM) photo of the silicon-carbon composite graphite precursor negative electrode material of the present invention after being carbonized by the powdered pressed ingots used heat treatment, then crushed, shaped, mixed, sieved and magnetic separation to obtain the modified silicon-carbon composite graphite anode material.

FIG. 6 is a present invention flow chart of a method for preparing a high-performance silicon-carbon composite graphite material.

### DETAILED DESCRIPTION OF PREFERRED EMBODIMENTS

The present invention will be further described in detail below in conjunction with specific embodiments.

### Embodiment

Take 200 g of artificial graphite powder with an average particle size of 14.3 um, and 100 g of Mesocarbon microbeads (MCMB) powder with an average particle size of 11.7 um, and 500 g of silicon powder with an average particle size of 5.8 um, and 200 g of pitch powder with an average particle size of 2.1 um, put into the VC high-speed mixer, mix for 30 minutes, put the mixed uniform powder into the mold, use an oil hydraulic press to press the powder in the mold into ingots, and then perform high-temperature carbonization heat treatment. The heat treatment temperature rise rate is 5° C./min to a temperature of 1050° C., maintaining the temperature for 3 hours and then cooling to room temperature. Use a jet mill to grind it to an average particle size of 12 um. After sieving, control the maximum particle size to less than 40 um to obtain a silicon-carbon composite graphite material A1.

### Comparative Example

Take the average particle size 5.8 um of the original silicon powder as comparative example A2.

Negative electrode material coating:
1. First mix 0.1 wt % trace amounts of oxalic acid and 10 wt % binder polyvinylidene fluoride (PVDF) into N-Methylpyrrolidone (NMP) solvent, stir evenly for 20 minutes to make the polyvinylidene fluoride (PVDF) evenly dispersed in the solvent mixture.
2. Place the graphite composite material A1 and A2 powder into the evenly stirred mixture and continue stirring for 20 minutes.
3. The mixed liquid forms a slurry, which is evenly coated at 130 um on a copper foil with a scraper, dried at 100° C. to remove the residual solvent, rolled at a rolling rate of 25%, and then dried at 150° C. for drying.

The battery assembly:
1. Cut the fully coated negative electrode piece into a circular plate with a diameter of 13 mm, and use lithium metal foil as the positive electrode.
2. Assemble the components required for the coin-type battery sequentially in a dry atmosphere control room, and add an electrolyte solution, which is 1M lithium hexafluorophosphate (LiPF6) (solute), ethylene carbonate (EC)/ethyl methyl carbonate (EMC) (Solvent)(Volume ratio=1:2), the coin-type battery is completed.
3. The assembled coin-type battery is subjected to a continuous charge and discharge performance test. The charge and discharge current density is 0.6 mA/cm². The constant current density is continuously charged and then discharged 10 times. The charge cut-off voltage is 2V (vs. Li/Li+), the discharge cut-off voltage is 0.005V (vs. Li/Li+).

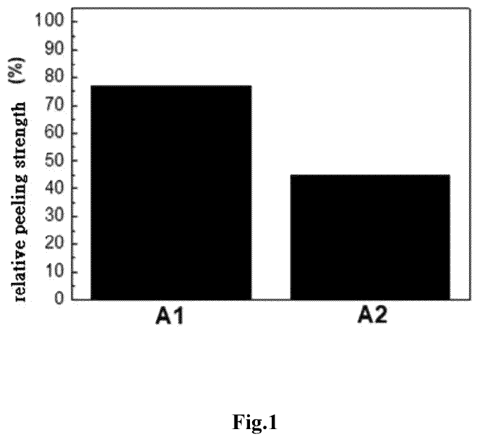

As shown in FIG. 1, the performance of A1 and A2 shown in current collector peeling strength. The A2 peel strength of the original silicon powder material as a comparative example is only 45.1% under the PVDF binder system, which is easy for the intercalation and deintercalation of lithium ions during the charging and discharging process in lithium batteries, and which causes the A2 silicon material to peel off from the copper foil current collector due to excessive expansion, resulting in a rapid decrease in cycle life. The A1 material obtained by processing the silicon material powder according to the method in the embodiment, its peel strength increased to 75.7% under the PVDF binder system, which is close to the peel strength of commercial pure graphite anode formula. It is because A1 completely covers the silicon material due to the graphite and the binder, filling the uneven surface of the silicon material, so that it can adhere better to the copper foil substrate with the PVDF glue.

As shown in Table 1, that can be shown at a charge and discharge current of 0.6 mA/cm² of about 0.2 C, the discharge capacity of A1 and A2 is 1658 mAh/g and 3275 mAh/g respectively. The 1st coulombic efficiency of A1 and A2 is respectively 86.3% and 65%. After 10 cycles cycle, the discharge capacity of A1 and A2 is 1497.2 mAh/g and 654.2 mAh/g respectively, the cycle life capacity retention is respectively 90.3% and 19.7%. Although the initial discharge capacity of A2 silicon material is 3275 mAh/g, which is higher than A1's 1658 mAh/g, after 10 cycles charge and discharge cycles, A2 severely declines to 654.2 mAh/g. However, The discharge capacity of A1 is still 1497.2 mAh/g, which is much higher than A2. Therefore, it can be found that through the graphite and the binder, the silicon material is completely and tightly sealed inside the graphite particles using pressure, the outer layer thereof has a thick amorphous carbon uniformly tightly coated to fill the surface defects caused by grinding of the silicon material, thereby improving the 1st coulombic efficiency. The 1st coulombic efficiency of A1 and A2 is 86.3% and 65% respectively. It is obvious that the A1 material is better than the original silicon of A2.

TABLE 1
A1, A2 electrochemical properties under the
charge and discharge current of 0.6 mA/cm²:

| Electrochemical properties | A1 | A2 |
|---|---|---|
| First charge capacity (mAh/g) | 1921 | 5037 |
| First discharge capacity (mAh/g) | 1658 | 3275 |
| First Coulombic efficiency (%) | 86.3 | 65.0 |
| 10th discharge capacity (mAh/g) | 1497.2 | 645.2 |
| 10th discharge capacity retention (%) | 90.3 | 19.7 |

The first discharge capacity of the A1 material obtained through the embodiment is 1658 mAh/g, which is higher than the capacity 350 mAh/g of conventional lithium battery negative electrode material. With different capacity designs, it can be used alone in the lithium battery design. The anode material therein can also be mixed with graphite material, which is used in most lithium battery designs. After the mold is enlarged and adjusted, it can be produced in large quantities. It can be a commercial silicon-carbon composite graphite anode material.

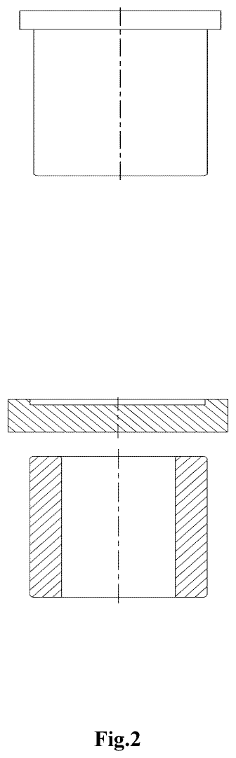

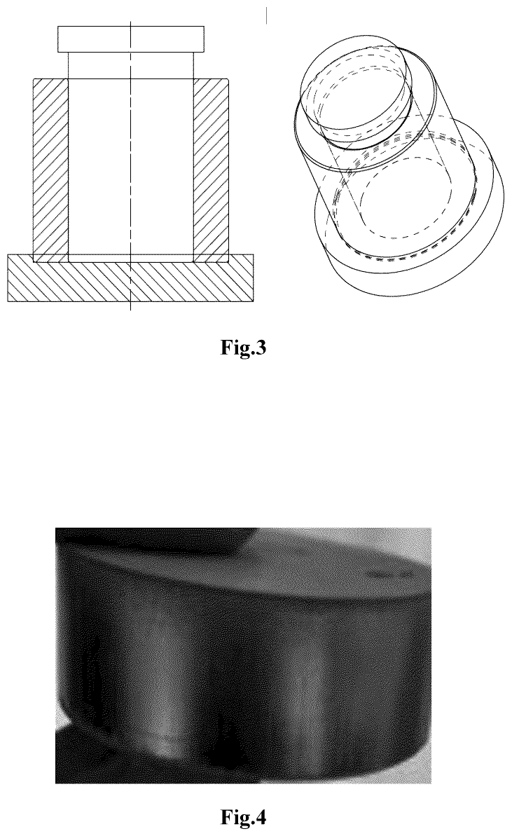

Please refer to FIGS. 2 and 3, which are the mold schematic diagrams of the silicon-carbon composite graphite material of the present invention. After mixing a graphite material 11 with one or several silicon 12 and a binder 13, it is filled into the mold, then pressure is applied therein to press it into an ingot, and a precursor anode material ingot containing silicon-carbon composite graphite is produced.

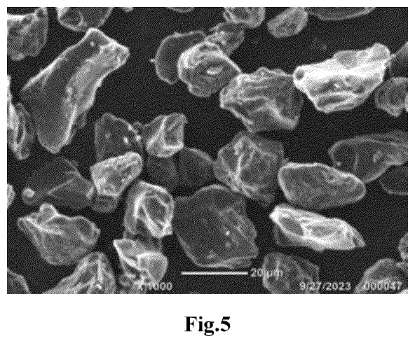

Please refer to FIGS. 4 and 5, which are silicon-carbon composite graphite precursor anode material ingots of the present invention. After heat treatment and carbonization, then crushing, shaping, mixing, sieving, and magnetically separating to obtain the scanning electron microscope (SEM) photo of the modified silicon-carbon composite graphite anode material. It has good electrical conductivity and can seed silicon tightly and completely in graphite carbon, improving the electrical performance of lithium-ion secondary batteries. It has a more stable reaction to the electrolyte and better charge and discharge cycle performance, so it can be used as Lithium-ion battery anode material.

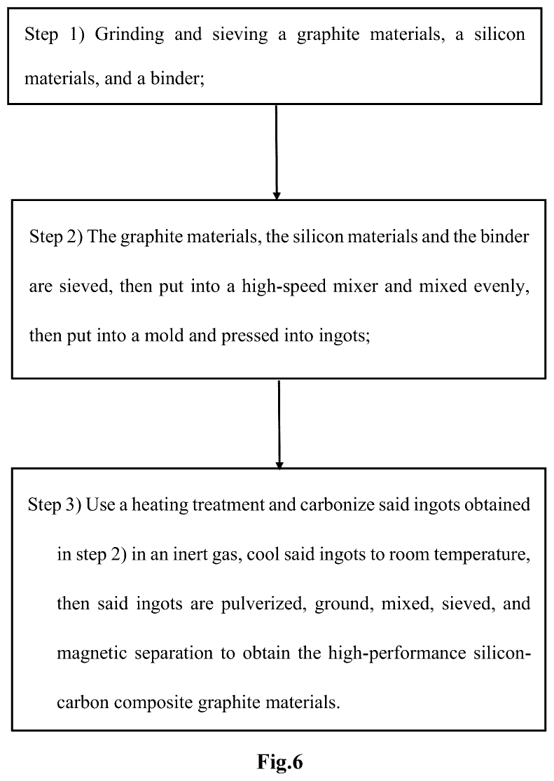

As shown in FIG. 6. It is a present invention flow chart of a method for preparing a high-performance silicon-carbon composite graphite material.

The foregoing description are only embodiments of the present invention. It should be pointed out that for those of ordinary skill in the art, various changes and modifications, substitutions and modifications that can be made to these embodiments without departing from the technical principles of the present invention. These changes, modifications, substitutions and modifications should also be regarded as the protection scope of the present invention.

What is claimed is:

1. A method for preparing a high-performance silicon-carbon composite graphite material, comprising:
Step 1) grinding and sieving a graphite material, a silicon material, and a binder;
Step 2) the grinded and sieved graphite material, silicon material and binder being put into a high-speed mixer and mixed evenly, and then put into a mold and pressed into ingots; and
Step 3) using a heating treatment and carbonizing the ingots obtained in step 2) in an inert gas, cooling the ingots to a room temperature, then the ingots being pulverized, ground, mixed, sieved, and magnetic separation to obtain the high-performance silicon-carbon composite graphite material.

2. The method as in claim 1, wherein the graphite material is at least one of artificial graphite and mesocarbon microbeads, a particle size thereof after sieving is 2-55 um.

3. The method as in claim 1, wherein the silicon material is at least one of silicon and silicon oxide (SiOx), a particle size thereof after sieving is 5-30 um.

4. The method as in claim 1, wherein the binder is at least one of petroleum pitch, coal pitch, and phenolic resin, a particle size thereof after sieving is 2-10 um.

5. The method as in claim 1, wherein a weight ratio of the graphite material, the silicon material, and the binder in step 2) is 1-1.2:4.8-5.5:1.8-2.4.

6. The method as in claim 1, wherein a temperature rise rate of the heating treatment in step 3) is 1-10° C./min, a heat treatment temperature is 800-1100° C., and heat treatment time is 1-15 hours.

7. The method as in claim, wherein the inert gas is at least one of argon and nitrogen.

8. The method as in claim 1, wherein a particle size of the high-performance silicon-carbon composite graphite material is 5-40 um.
